(19) United States
(12) Patent Application Publication
(10) Pub. No.: US 2024/0360010 A1
(43) Pub. Date: Oct. 31, 2024

(54) APPARATUS FOR ULTRAVIOLET DISINFECTION OF WATER

(71) Applicant: Blu Technology, LLC, Kalamazoo, MI (US)

(72) Inventors: Corbin Collet, Portage, MI (US); April Jennesis-Collet, Kalamazoo, MI (US)

(21) Appl. No.: 18/641,863

(22) Filed: Apr. 22, 2024

Related U.S. Application Data
(60) Provisional application No. 63/498,960, filed on Apr. 28, 2023.

(51) Int. Cl. C02F 1/32; C02F 1/44

(52) U.S. Cl. CPC C02F 1/325; C02F 1/444; C02F 2201/3222; C02F 2201/3227; C02F 2303/04

(57) ABSTRACT

A water treatment system includes a disinfection apparatus and a power source. The disinfection apparatus is arranged within a canister and includes an ultraviolet light fixture configured to disinfect water entering the disinfection apparatus and passing through the ultraviolet light fixture. An inlet connector of the canister is directly coupled to the disinfection apparatus and configured to allow water to enter the ultraviolet light fixture. An outlet connector of the canister is configured to output disinfected water received from the ultraviolet light fixture. The power source is communicatively coupled to the disinfection apparatus and configured to output a DC voltage to the disinfection apparatus. A flow sensor of the disinfection apparatus is configured to apply the DC voltage to the ultraviolet light fixture when a flow of water is detected.

### CROSS REFERENCE TO RELATED APPLICATION

The present application claims priority of U.S. provisional application Ser. No. 63/498,960 filed Apr. 28, 2023, which is hereby incorporated herein by reference in its entirety.

### FIELD OF THE INVENTION

The present invention is directed to water disinfection, and in particular, to portable water disinfection.

### BACKGROUND OF THE INVENTION

Conventional filtration, such as sediment filtering and finer micron filtering, has been used to filter water of sand, sediment, contaminants, etc. Water filtration systems are typically used for whole house (multiple faucet) water filtration or for filtering water supplied to a single faucet. Other water filtration systems may be portable and optimized for size and weight allowing them to be carried along for use while hiking and/or camping.

### SUMMARY OF THE INVENTION

Embodiments of the present invention provide a system and apparatus for disinfecting water. An exemplary treatment system includes a disinfection apparatus that includes a UV light fixture with one or more UVC modules for disinfecting water as the water passes through the disinfection apparatus. The disinfection apparatus is housed within a canister. The one or more UVC modules are arranged in a parallel configuration within the canister such that water entering the disinfection apparatus is divided among the arrangement of UVC modules for disinfection. The disinfection apparatus includes a flow switch positioned at a water inlet of the disinfection apparatus and configured to apply a DC voltage to the UVC modules when a flow of water through the flow switch is sensed. In one embodiment, the disinfection system includes at least one filter and an optional pump, with each filter and optional pump contained within a corresponding canister, wherein the filter, pump, and disinfection apparatus are coupled together via couplings between each respective canister. The disinfection system includes a controller for turning the pump ON and OFF. The controller may also control the delivery of the DC voltage to the pump (where equipped) and the disinfection apparatus. The pump and/or UV light fixture may utilize the same voltage level, e.g., 12V DC. The DC voltage is drawn from a power source that is plugged into the disinfection system. Optionally, the power source is a battery. Alternatively, the power source may be an AC-to-DC converter outputting a DC voltage. The power source outputs a current sufficient to power both the pump and the UV light fixture. The controller may turn ON the pump while cutting off the supply of DC voltage to the disinfection apparatus. The power source may also be coupled to a solar panel for charging. The use of a solar panel and battery allows for the portable use of the disinfection system away from conventional power sources (i.e., off-grid). The battery may be recharged through the use of a recharging unit that receives power from a variety of power sources, e.g., AC voltage sources, DC voltage sources, and a solar panel.

In an aspect of the present invention, a water treatment system includes a disinfection apparatus and a power source. The disinfection apparatus includes an ultraviolet light fixture configured to disinfect water entering the disinfection apparatus and passing through the ultraviolet light fixture. The disinfection apparatus is arranged within a canister. An inlet connector of the canister is directly coupled to the disinfection apparatus and configured to allow water to enter the ultraviolet light fixture. An outlet connector of the canister is configured to output disinfected water received from the ultraviolet light fixture. The power source is communicatively coupled to the disinfection apparatus and configured to output a DC voltage to the disinfection apparatus. A flow sensor of the disinfection apparatus is configured to apply the DC voltage to the ultraviolet light fixture when a flow of water is detected.

In another aspect of the present invention, a water treatment system includes a disinfection apparatus and a power source. The disinfection apparatus includes a plurality of ultraviolet light fixtures arranged in a parallel configuration within a canister, such that water entering the disinfection apparatus is divided among the arrangement of ultraviolet light fixtures. An inlet connector of the canister is directly coupled to the disinfection apparatus and configured to allow water to enter the arrangement of ultraviolet light fixtures. An outlet connector of the canister is configured to output disinfected water received from the arrangement of ultraviolet light fixtures. The power source is communicatively coupled to the disinfection apparatus and configured to output a DC voltage to the disinfection apparatus. The power source is one or more of an internal and/or external battery, an AC-to-DC power supply, or a solar panel.

In an aspect of the present invention, the treatment system includes a filtering apparatus. The filtering apparatus includes one or more filters (each arranged in a respective canister) and optionally an electric pump (arranged in a canister) configured to pump water when a DC voltage is applied to the pump. The one or more filters are configured to filter water that is drawn into the disinfection system by the pump. The filters and the optional pump are directly coupled without intermediary fittings/couplings via their respective canisters. The disinfection apparatus is coupled to the output of the filtering apparatus such that filtered water is fed to the disinfection apparatus. The disinfection system also includes a controller for controlling the operation of the pump. In one embodiment, the controller also controls the operation of the disinfection apparatus.

In an aspect of the present invention, the treatment system is configured to receive filtered water for disinfection. The disinfection system may be configured to couple to a filter system for filtering water passing through the filter system, such that filtered water is passed to the disinfection system.

In an aspect of the present invention, the arrangement of UV light fixtures is arranged in parallel within a canister, such that each disinfects a portion of the water passing through the disinfection apparatus.

In another aspect of the present invention, the DC voltage is 12 VDC. The power source may be a battery or an AC-to-DC converter. The power source is coupled to the power port via a power cable. Optionally, the power source is selectively coupled to a solar panel for charging the power source. The filter/disinfection system may also be mobile and powered via a portable battery. The portable battery may be attachable to the filter/disinfection system.

In an aspect of the present invention, the UV light source is an LED ultraviolet source configured to emit ultraviolet light. The LED UV light source may also emit UVC light.

Thus, a mobile treatment system, powered by a low voltage DC power source, is provided for disinfecting any available water source via a unique arrangement of one or more ultraviolet disinfection devices that allows for a larger flow rate than in conventional systems of similar size. When equipped with a plurality of ultraviolet disinfection devices, the ultraviolet disinfection devices are arranged in parallel. Rather than disinfecting water in a conventional ultraviolet disinfection device, exemplary embodiments include one or more ultraviolet disinfection devices arranged in a single canister. In one embodiment, the arrangement of multiple ultraviolet disinfection devices is a set of smaller ultraviolet disinfection devices (each with a lower power demand) that provide the desired flow rate of disinfected water. The set of ultraviolet disinfection devices are arranged in a parallel configuration within the canister such that the incoming water is divided among the set of ultraviolet disinfection devices. The disinfection system may also include one or more filters and optionally a water pump (each arranged within a respective canister). The one or more filters are configured to filter the water to a desired level of filtration. The pump draws water from an available source and pushes or draws the water through the disinfection system.

These and other objects, advantages, purposes, and features of the present invention will become apparent upon review of the following specification in conjunction with the drawings.

### BRIEF DESCRIPTION OF THE DRAWINGS

FIG. 1A is a block diagram of a disinfection system for disinfecting water drawn into the disinfection system in accordance with the present invention;

FIG. 1B is a block diagram of an exemplary water disinfection system that includes an arrangement of filters coupled to the disinfection system of FIG. 1A for filtering and disinfecting water drawn into the water disinfection system in accordance with the present invention;

FIG. 1C is a block diagram of the water disinfection system of FIG. 1B further including a pump for drawing water into the water disinfection system in accordance with the present invention;

FIG. 2A is a block diagram of the water disinfection systems of FIGS. 1A, 1B, or 1C receiving power from a power source and an optional solar panel such that a pump of the water disinfection system draws water from a source for sterilization in accordance with the present invention;

FIG. 2B is a block diagram of an alternative embodiment of the water disinfection system of FIG. 2A incorporating a different battery and charging system in accordance with the present invention;

FIG. 3 is a perspective view of components of an exemplary water disinfection device configured for mounting in a water treatment system chassis in accordance with the present invention;

FIG. 4A is a top view of an exemplary water disinfection apparatus in accordance with the present invention;

FIGS. 4B, 4C, and 4D are side views of interior components of the exemplary water disinfection apparatus of FIG. 4A in accordance with the present invention;

FIG. 4E is a bottom view of the water disinfection apparatus of FIGS. 4A, 4B, 4C, and 4D in accordance with the present invention;

FIG. 5 is a perspective view of the water disinfection apparatus of FIG. 4 illustrating an exemplary canister, lid, and fixing plate;

FIG. 6A is a perspective view of interior components of an exemplary water disinfection apparatus in accordance with the present invention;

FIGS. 6B, 6C, and 6D are perspective views of interior components of an exemplary water disinfection apparatus illustrating water tubing connections to exemplary UVC sterilization modules in accordance with the present invention;

FIG. 7A is a schematic diagram illustrating an exemplary UVC sterilization module in accordance with the present invention;

FIG. 7B is a schematic diagram illustrating another exemplary water disinfection apparatus and illustrating a parallel arrangement of UVC sterilization modules in accordance with the present invention;

FIG. 8A is a perspective view of another water disinfection apparatus in accordance with the present invention;

FIGS. 8B, 8C, 8D, 8E, and 8F are perspective views of components of the water disinfection apparatus of FIG. 8A in accordance with the present invention;

FIG. 9 is a schematic diagram of the water disinfection apparatus of FIG. 8A illustrating an exemplary arrangement of components in accordance with the present invention;

FIGS. 10A, 10B, 10C, 10D, and 10E are views of an exemplary water treatment system that includes the water disinfection apparatus of FIG. 8A in accordance with the present invention; and

FIGS. 11A, 11B, 11C, 11D, and 11E are views of another exemplary water treatment system that includes the water disinfection apparatus of FIG. 8A in accordance with the present invention.

### DESCRIPTION OF THE PREFERRED EMBODIMENTS

Referring to the drawings and the illustrative embodiments depicted therein, a mobile disinfection system provides mobile water disinfection. In one embodiment, the disinfection system receives filtered water for disinfection. Optionally, the disinfection system may be implemented into a filter/disinfecting system which provides mobile water filtering and disinfection. The mobile disinfection system or filter/disinfecting system (hereinafter referred to as a disinfection system) is powered via a low-voltage DC power source. The disinfection system may include a filter apparatus that includes one or more filters and an optional fluid pump. The one or more filters filter water that is drawn into the filter apparatus by the fluid pump. The filters and pump are directly coupled (without the use of intermediary fittings/couplings), and with quick-connect inlet/outlet fittings also directly coupled to the filters. The disinfection system includes a disinfection apparatus that includes an ultraviolet (UV) light source for disinfecting the filtered water as filtered or unfiltered water passes through the disinfection apparatus. The UV light source may include light emitting diodes (LEDs) configured to emit ultraviolet light for disinfection. The UV light source may be configured to emit UV-C light. As described in detail herein, the UV light source may include a parallel arrangement of UV light fixtures, such that water entering the disinfection apparatus is divided among the arrangement of UV light fixtures for disinfection. This exemplary parallel arrangement allows for a higher water flow than in conventional water treatment devices in a similar size or package. Such an exemplary parallel arrangement also provides a desired flow rate of disinfected water in a smaller configuration or package as compared to conventional disinfection systems providing the desired flow rate. The disinfection apparatus includes a flow switch for controlling the operation of the UV light fixtures. The flow switch applies DC voltage to the UV light fixtures when a flow of water is sensed. A DC voltage is provided by a power source, which may include a battery or optionally an AC-to-DC converter. Thus, as described herein, an exemplary water disinfection system provides a desired flow rate in a smaller package than possible in conventional disinfection systems. Other benefits of the exemplary embodiments include a lower current draw, a smaller heat sink, and a significantly smaller package size as compared to the single larger UVC LED arrangement needed to produce an equivalent output (with its resulting larger current draw and larger heat sink). In one embodiment, the exemplary portable water disinfection system may be packaged in a standard five-inch canister to provide a portable means of water sterilization for implementation in any water treatment scenario. In other embodiments, the exemplary portable water disinfection system may be packaged in canisters of various sizes (e.g., 5 inches, 7 inches, 10 inches). Such exemplary canister sizes are not intended to limit the canister sizes used to contain exemplary portable water disinfection system embodiments (other canister sizes are possible without departing from the scope of the embodiments described herein).

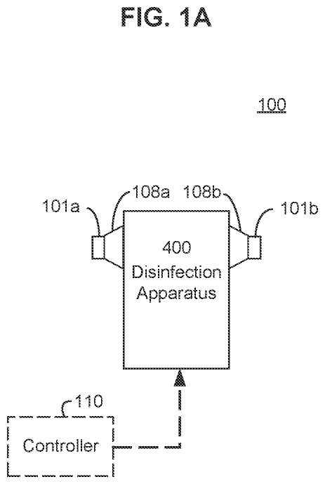

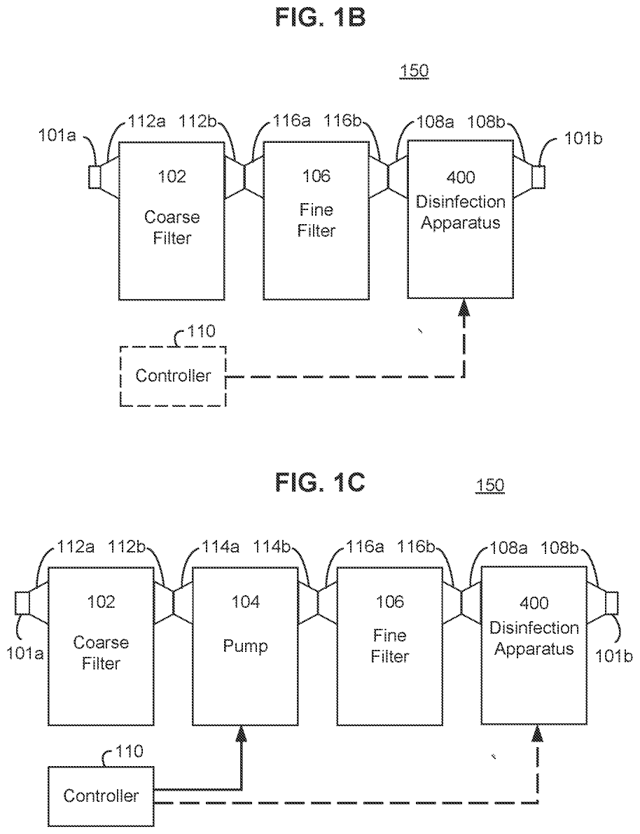

FIG. 1A illustrates the components of an exemplary disinfection system 100. As illustrated in FIG. 1A, an exemplary disinfection apparatus 400 receives water via an inlet 101a to an input 108a, while disinfected water is output, via an outlet 101b, from an output 108b of the disinfection apparatus 400. The disinfection apparatus 400 may receive unfiltered water or filtered water. As discussed herein, the disinfection apparatus 400 may be coupled to a filter apparatus. The inlet 101a and outlet 101b include quick-disconnect functionality for rapid and reliable coupling of hoses or conduit to the disinfection apparatus 100. An exemplary embodiment of the disinfection apparatus 400 removes 99.999% of microorganisms, such that such a disinfection apparatus 400 may be considered as providing sterilization of the water.

FIGS. 1B and 1C illustrate the components of an exemplary disinfection system 150 that includes an arrangement of filters with the disinfection apparatus 400. As illustrated in FIGS. 1B, a pair of filters 102, 106, with or without a fluid pump 104 between them, are directly coupled. An output 112b of filter 102 directly couples to an input 116a of filter 106, while an output 116b of the filter 106 directly couples to an input 108a of a disinfection apparatus 400. Alternatively, a fluid pump 104 is positioned between the filters 102, 106. FIG. 1C illustrates the output 112b of filter 102 directly coupling to an input 114a of fluid pump 104, while an output 114b of the fluid pump 104 directly couples to the input 116a of the filter 106. Note that an inlet 101a is directly coupled to an input 112a of filter 102, while an outlet 101b is directly coupled to an output 108b of the disinfection apparatus 400. As illustrated in FIG. 1C, a controller 110 is communicatively coupled to the fluid pump 104 for controlling the operation of the fluid pump 104. As illustrated in FIGS. 1A, 1B, and 1C, controller 110 may also be optionally communicatively coupled to the disinfection apparatus 400 for controlling the operation of the disinfection apparatus 400. Via an ON/OFF switch that is communicatively coupled to the controller 110, a user turns the fluid pump and (optionally) the disinfection apparatus 400 ON and OFF as desired.

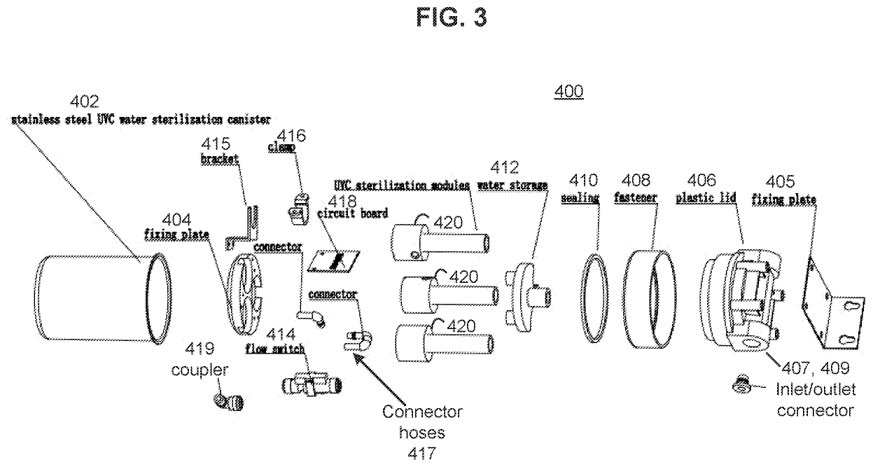

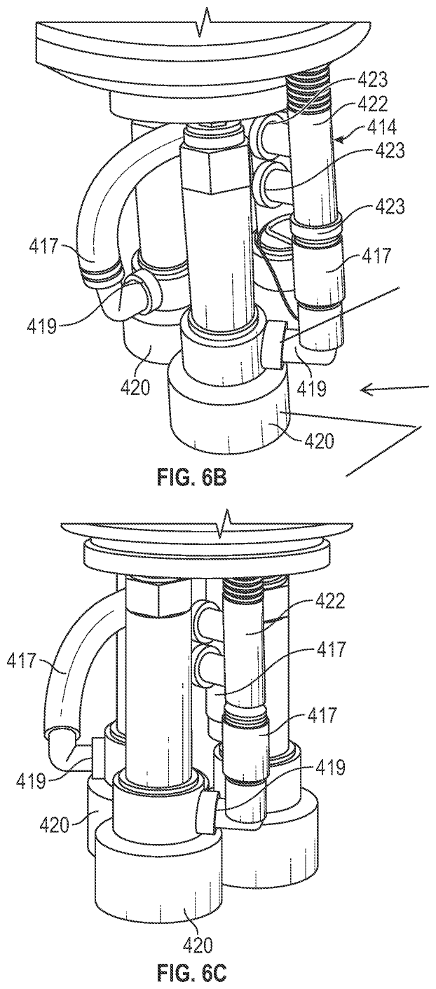

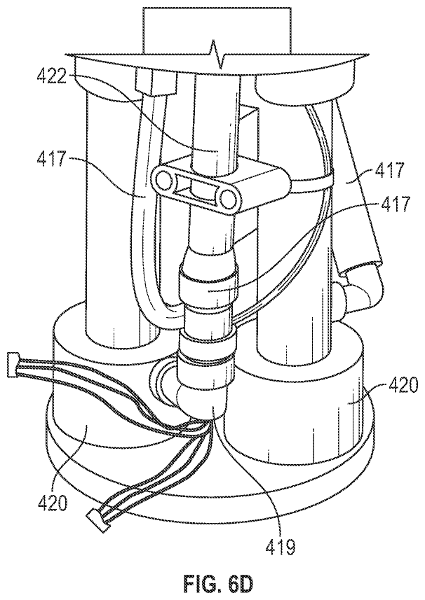

As described herein, the disinfection apparatus 400 includes a flow switch 414 for turning the UVC devices ON or OFF in response to the detection of water flowing through the flow switch 414 (see FIGS. 3 and 6B). That is, a DC voltage supplied to the disinfection apparatus 400 is applied to the UVC devices (via the flow switch 414) when a flow of water is sensed by the flow switch 414.

Optionally, the controller 110 may also control the pumping rate of the fluid pump 104 via a throttle functionality. The disinfection apparatus 150 may also include fewer or more filters. While FIG. 1C illustrates the fluid pump 104 arranged in-line between the coarse filter 102 and the fine filter 106, the fluid pump 104 may be placed in-line before the filters 102, 106 and pushing water through the filters 102, 106, or in-line after the filters 102, 106 and drawing water into the filters 102, 106. As illustrated in FIG. 1C, a coarse filter 102 is configured to filter out sand/sediment before the water passes through the fluid pump 104 on the way to a fine filter 106. The fine filter may be a micron filter configured to prevent anything larger than the filter's—micron pores from passing through. Sub-micron filters may also be used, e.g., a 0.2-micron filter configured to filter out anything larger than 0.2 microns.

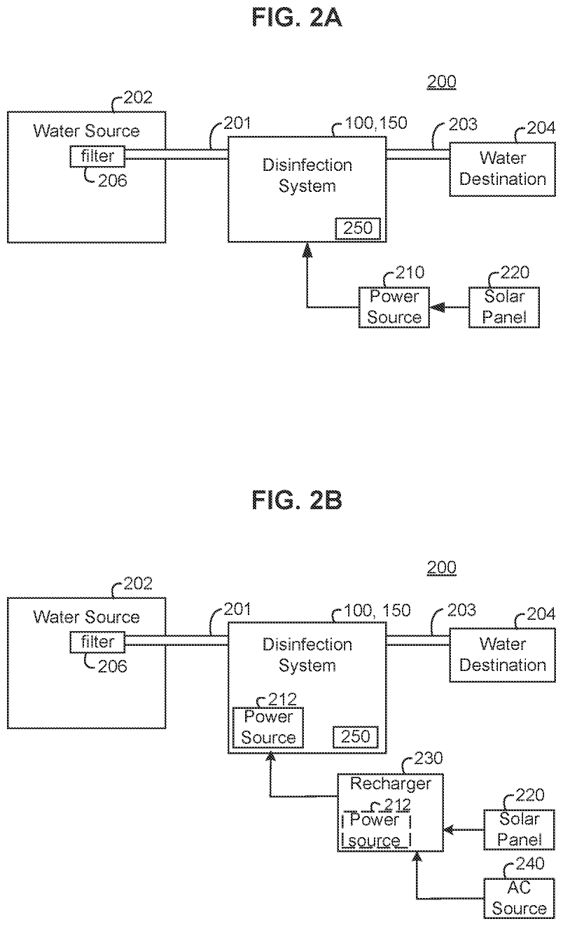

FIG. 2A illustrates the disinfection system 100, 150 of FIGS. 1A, 1B, and 1C in operation. As illustrated in FIG. 2A, the disinfection system 100, 150 is coupled to an inlet hose 201 and an outlet hose 203. The inlet hose 201 is placed into any available water supply 202 for filtering and/or disinfecting, while the outlet hose 203 is positioned to deliver disinfected water (with optional filtering) to a destination 204. As noted herein, the water source 202 may be filtered water. The inlet hose 201 may optionally include an inlet filter 206 to filter out organic materials (vegetable matter, algae, etc.) The inlet hose 201 may further include a float or similar arrangement to aid in positioning the inlet filter 206 into the water for drawing water into the inlet hose 201 (keeping the inlet hose 201 from touching the bottom of a body of water). Note also that a power source 210 is coupled to the disinfection system 100, 150. FIG. 2A also illustrates the use of an optional solar panel 220 that charges the power source 210 (battery). In one embodiment the power source 210 is a battery, in another embodiment, the power source 210 is an AC-to-DC converter coupled to an AC source 240. Whatever the source, the power source 210 is configured to output a low voltage DC, e.g., 12V DC. The power source 210 will be sufficient to power the disinfection system 100, 150 (that is, both the optional fluid pump 104 and the disinfection apparatus 400). On average, the fluid pump 104 will output an average of 2.2 gallons per minute. The power source 210 will output a low voltage (e.g., 12 V DC) at 1.0 amps to 10 amps. As illustrated in FIG. 2A, the disinfection system 100, 150 also includes an LED 250 for illuminating a green indicator light when water is flowing through the disinfection system 100, 150. The LED 250 will illuminate a red indicator light when water is not flowing through the disinfection system 100.

FIG. 2B illustrates an alternative embodiment of the filter arrangements of FIG. 2A. In FIG. 2B, the power source 210 of FIG. 2A is replaced with a power source 212 removably coupled into the housing of the disinfection system 100, 150. In an aspect of the present embodiment, the removable power source 212 is a rechargeable battery 212. The rechargeable battery 212 may be either recharged (via a recharger 230) while still inserted into the disinfection system 100, 150, or removed from the disinfection system 100, 150 and inserted into a charging port of the recharger 230. The filtering of water with mobile water treatment systems that employ a variety of different fixtures, support brackets and chassis for supporting the mobile water treatment system is described in detail in commonly owned U.S. patent application Ser. No. 17/847,855, which is hereby incorporated herein by reference in its entirety. As also illustrated in FIG. 2B, the disinfection system 100, 150 includes an LED 250 for illuminating a green indicator light when water is flowing through the disinfection system 100, 150. The LED 250 will illuminate a red indicator light when water is not flowing through the disinfection system 100.

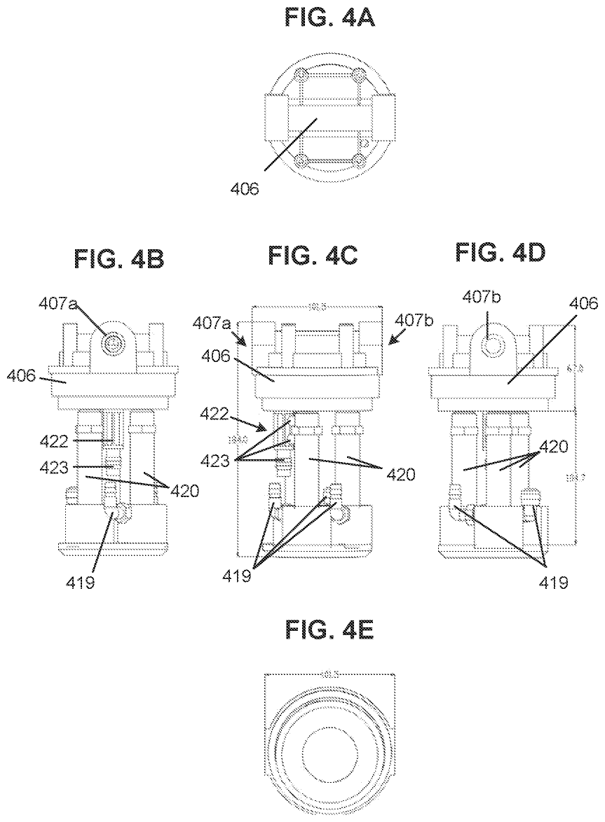

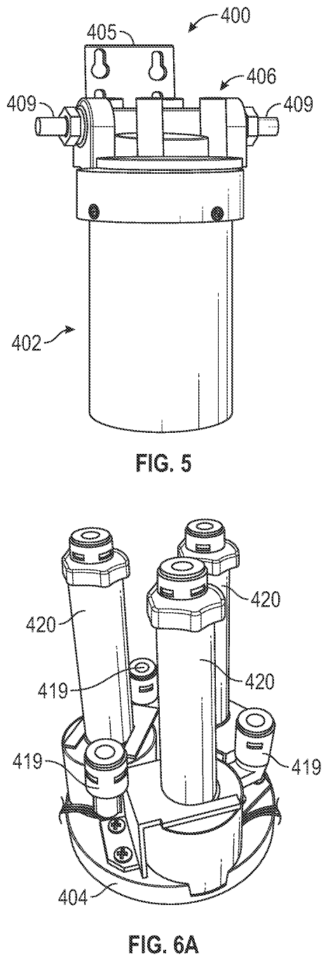

FIG. 3 illustrates the components of an exemplary disinfection apparatus 400. Three UVC disinfection modules 420 are arranged upon a bottom fixture plate 404, with each UVC disinfection module 420 including a coupler 419 for receiving a water connector hose/tube or conduit 417. Note the connector hoses/tubes or conduits 417 may be formed of plastic tubing (see FIGS. 6A-6D). On the opposite ends, the UVC disinfection modules 420 are received in a water storage fixture 412, which is coupled to a lid assembly 406 via a connection on the underside of the lid assembly 406. The water storage fixture 412 accumulates disinfected or sterilized water from the UVC disinfection modules 420 for discharge from the lid assembly 406. The lid assembly 406 is also fitted with inlet/outlets 407 for receiving water tubing (e.g., via quick-connect couplers 409 inserted into the inlet/outlets 407) on either side. The lid assembly 406 is configured to receive mounting screws for securing to a top fixture plate 405. With the UVC disinfection modules 420, the bottom fixture plate 404, and the water receiver fixture 412 coupled together, they may be inserted into a standard five-inch canister 402 which couples to the lid assembly 406 via a sealing ring 410 and fastener 408. As discussed herein, other canister sizes (e.g., 5 inches, 7 inches, and 10 inches) are also possible. Note that FIG. 3 illustrates a plurality of water connector hoses/tubes or conduits 417 for coupling each of the UVC sterilization modules 420 (via respective couplers 419) to a water outlet 422 on the underside of the lid assembly 406 (see FIGS. 4 and 5). As illustrated in FIGS. 3, 4, and 5, a bracket 415 and clamp 416 are used to retain/hold the water connection hoses/tubes or conduit 417 in place. In one embodiment, the canister 402 is formed of stainless steel. In other embodiments, the canister 402 may be formed of other metals or formed of plastic. The lid assembly 406 in one embodiment is formed of plastic. The lid assembly 406 may also be formed of stainless steel or other metals.

The operation of the UVC sterilization modules 420 is controlled by a controller circuit board (“controller”) 418. Note that the UVC sterilization modules 420 and the controller 418 are energized (i.e., supplied with a low DC voltage) in response to the flow switch 414 sensing a flow of water through the flow switch 414. The flow switch 414 is coupled in line with the inlet port 407a, and before the water outlet 422, such that the flow switch 414 senses the flow of water passing through on the way to the UVC sterilization modules 420. As discussed herein, the UVC sterilization modules 420 are arranged such that the entering water splits into three parallel streams of water for disinfection/sterilization in the UVC sterilization modules 420. Thus, as water flows through the flow switch 414, the DC voltage applied to the sterilization apparatus 400 is applied to the controller 418 and the UVC sterilization modules 420. Thus, exemplary embodiments of the disinfection apparatus 400 may operate independently from the operation of any other systems within a water treatment system (i.e., with the application of a DC voltage and a supply of water, the disinfection apparatus 400 will output disinfected water). As noted with respect to FIGS. 2A and 2B, when water is flowing through the disinfection apparatus 400, an LED indicator 250 will illuminate a green indicator light. The LED indicator 250 will illuminate a red indicator light when water is not flowing through the disinfection apparatus 400.

FIGS. 4B, 4C, and 4D provide interior side views of an exemplary disinfection apparatus 400. Three UVC sterilization modules 420 are arranged along with their corresponding couplers 419. FIGS. 4B and 4C also illustrate the water outlet 422 including a trio of outlet couplers 423 for receiving water connection hoses/tubing or conduits 417 to route the incoming water to the three UVC sterilization modules 420 via their corresponding couplers 419 (see also FIGS. 6A-6D). The water outlet 422 is in line with the inlet port 407a, such that water entering the lid assembly 406 is channeled to the water outlet 422 (via the flow switch 414) for delivery to the arrangement of UVC sterilization modules 420 (via respective hoses/tubing 417) (see FIGS. 3, 6B, and 7B). FIG. 4A is a top view of the lid assembly 406, while FIG. 4B is an underside view of the bottom fixture plate 404 (upon which the UVC sterilization modules 420 are seated. Thus, water entering an inlet port 407a of the lid assembly 406 is passed through the water outlet 422 divided amongst the three UVC sterilization modules 420 for sterilization. In other embodiments, the flow switch 414 may be implemented in alternative ways. For example, the flow switch 414 may be integrated into the water outlet 422. Thus, water enters the disinfection apparatus 400 via the inlet port 407a on the lid assembly 406, and disinfected/sterilized water exits the disinfection apparatus 400 via an outlet port 407b on the opposite side of the lid assembly 406. As discussed herein, the disinfected water exiting the UVC sterilization modules 420 is accumulated in a water storage device 412, which is coupled to the lid assembly 406 and in line with the outlet 407b of the lid assembly 406.

FIG. 5 illustrates an exemplary disinfection apparatus 400 enclosed within a lid assembly 406 and a canister 402. As noted herein, an exemplary lid assembly 406 is formed with plastic, while the canister 402 is formed of stainless steel. Other materials can be used for both. For example, the canister 402 may be formed of plastic or other metals, while the lid assembly 406 may be formed of stainless steel or other materials, such as other metals. FIG. 5 also illustrates a pair of couplers 409 screwed into the inlet/outlet ports 407 of the lid assembly 406, as well as a fixture plate 405 for mounting the disinfection apparatus 400 within a water filtration system or some other water treatment assembly.

FIG. 6A illustrates a bottom fixture plate 404 with mounted UVC sterilization modules 420. Note that a corresponding bracket 405 is used to mount each of the UVC sterilization modules 420 to the bottom fixture plate 404. FIG. 6A also illustrates a coupler 419 connected to each UVC sterilization module 420. Note that each of the UVC sterilization modules 420 and the couplers 419 are equipped with couplers, such as “quick-connect” couplers, for easy coupling and uncoupling of the water tubes. In FIGS. 6B-6D, the water outlet 422 is illustrated coupling water hoses/tubing or conduit 417 to each of the couplers 419 on each UVC sterilization module 420.

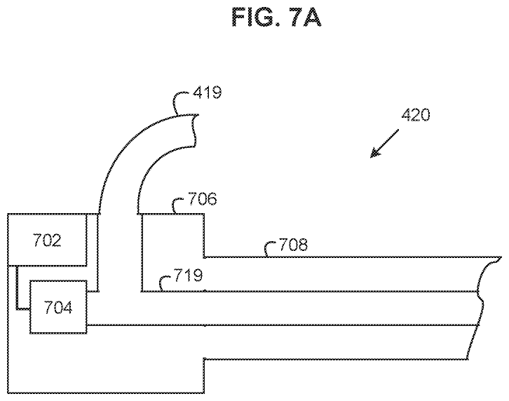

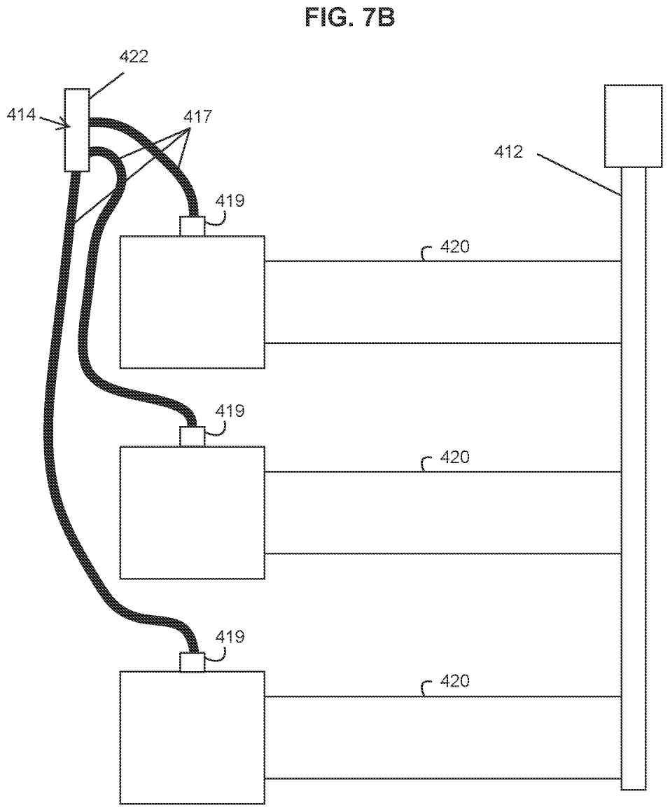

FIG. 7 is a block diagram illustrating a cross section of an exemplary UVC sterilization module 420 (not drawn to scale). A housing 706 of the UVC sterilization module 420 receives the coupler 419 and passes water into an internal chamber 719 which is exposed to a UVC light emitter unit 704 for disinfection or sterilization of the water passing through the UVC sterilization module 420 (i.e., by UV light disinfection). A control module 702 is communicatively coupled to the UVC light emitter unit 704 to control the UVC light emitter unit 704. In one embodiment the control module 702 and the UVC light emitter unit 702 are coupled together via control lines. In one embodiment the UVC light emitter unit 704 includes light emitting diodes (LEDs) that emit ultraviolet light. As discussed herein, the UVC light emitter unit 704 and the controller 702 are powered by low voltage DC, e.g., 12 V DC. This is the same voltage level as supplied to optional water pumps.

FIG. 7A is a block diagram illustrating a parallel arrangement of UVC sterilization modules 420a-c. Note that the components of the disinfection apparatus illustrated in FIG. 7A are not drawn to scale. Each UVC sterilization module 420 is illustrated receiving a hose/conduit 417 at their respective couplers 419, with the hose/conduits 417 supplying water from a water outlet 422. An exemplary three UVC sterilization modules 420 are illustrated in a parallel arrangement such that the water exiting the water outlet 422 (via the hoses/conduits 417) is divided among the parallel arrangement of UVC sterilization modules 420. Multiple streams of disinfected or sterilized water exit the UVC sterilization modules 420a-c to be accumulated via a water storage device 412, which is coupled to a lid assembly 406, such that the sterilized water exits the disinfection apparatus 400 (see FIGS. 3 and 4).

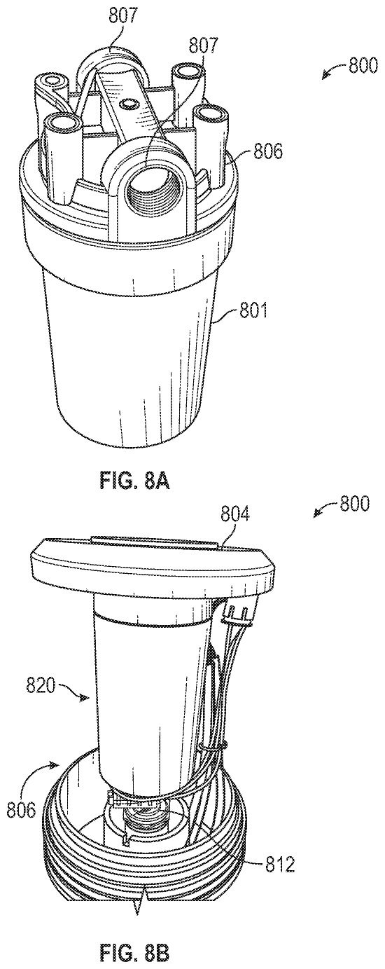

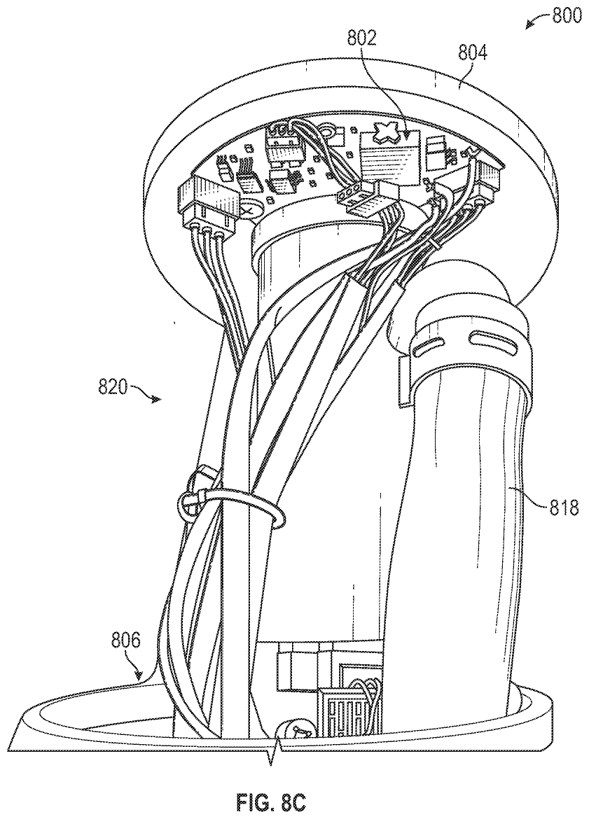

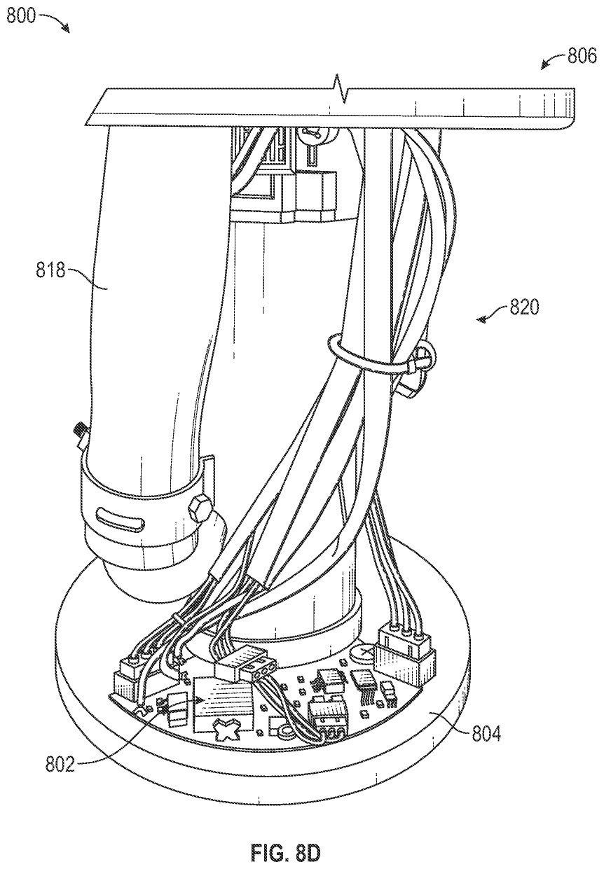

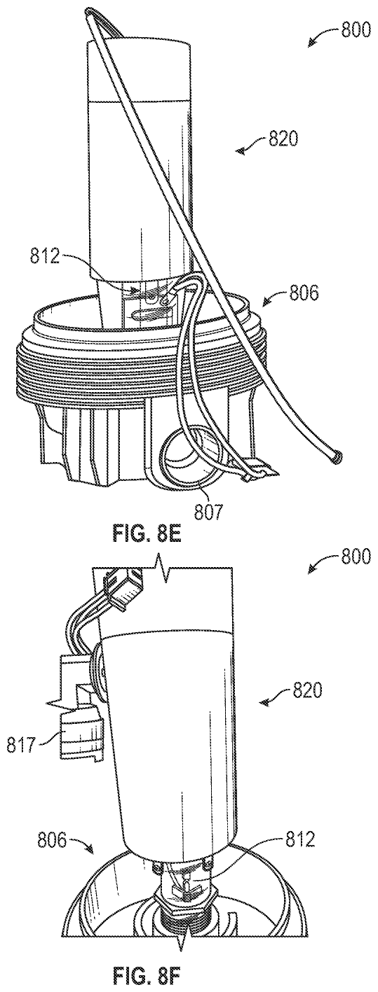

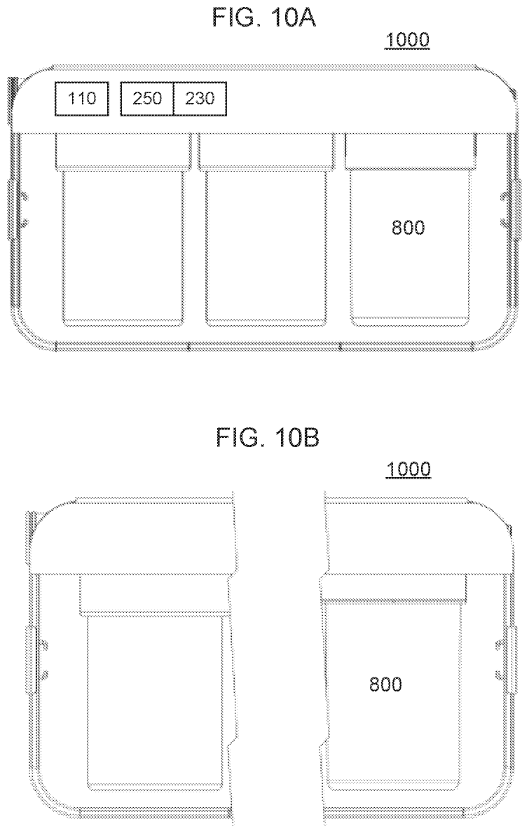

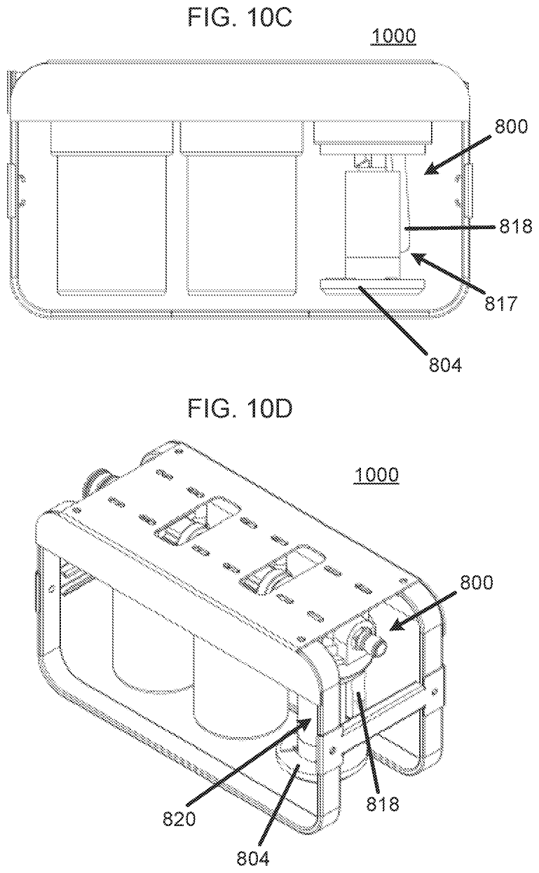

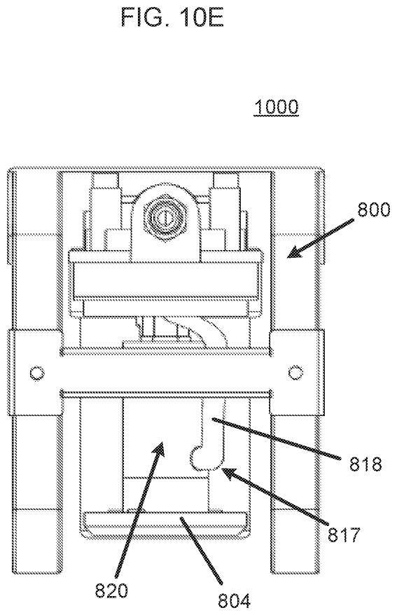

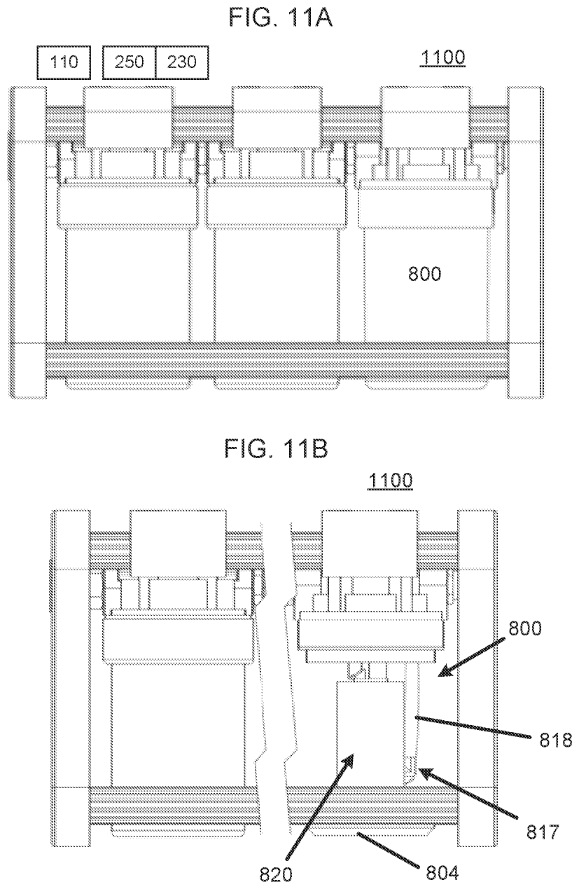

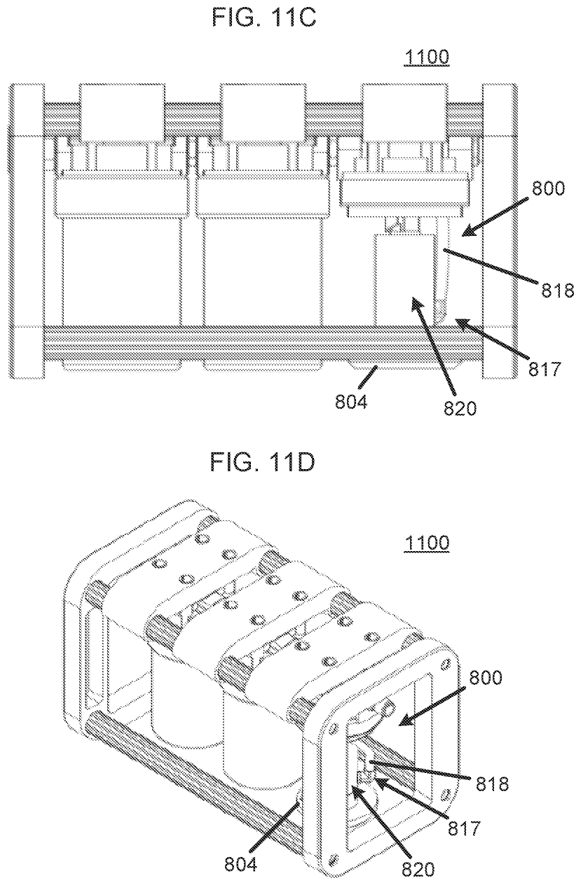

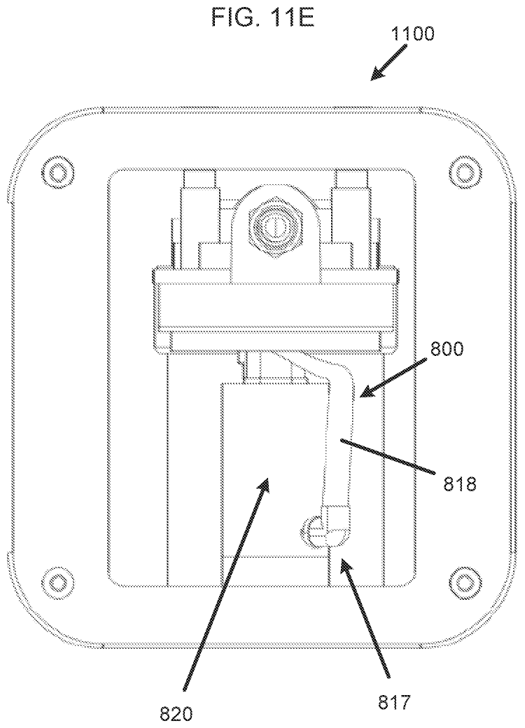

FIG. 8A illustrates an exemplary disinfection apparatus 800 enclosed within a lid assembly 806 and a canister 801. As noted herein, an exemplary lid assembly 806 is formed with plastic, while the canister 801 is formed of stainless steel. Other materials can be used for both. For example, the canister 801 can be formed of plastic or other metals, while the lid assembly 806 can be formed of stainless steel or other materials, such as other metals. FIG. 8A also illustrates inlet/outlet ports 807 of the lid assembly 806. As discussed herein, the disinfection apparatus 800 is configured for mounting within a water treatment system (e.g., water treatment systems 1000, 1100 of FIGS. 10 and 11, respectively).

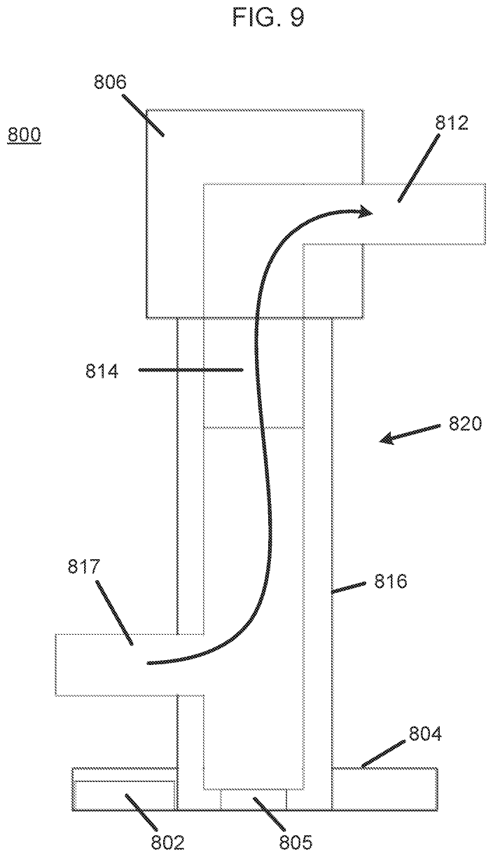

FIG. 8B illustrates a bottom fixture plate 804 with mounted UVC sterilization module 820. Note that the UVC sterilization module 820 is coupled to the lid assembly 806 via a water outlet 812 supplying sterilized (or purified) water from the lid assembly 806 via the outlet port of the inlet/outlet ports 807 (see FIG. 8A). In FIGS. 8C, 8D, and 8F, the UVC sterilization module 820 is illustrated with a water hose 818 coupled to a water inlet coupler 817. FIGS. 8C and 8D illustrate the water hose 818 coupling the lid assembly 806 (and the inlet port of the inlet/outlet ports 807) to the water inlet coupler 817 on the UVC sterilization module 820. FIGS. 8B and 8E illustrate additional views of the UVC sterilization module 820 coupled between the lid assembly 806 and the bottom fixture plate 804. FIGS. 8C and 8D illustrate an exemplary arrangement of a control module 802 and associated circuitry. Thus, as illustrated in FIGS. 8A-8F, the disinfection apparatus 800 is arranged such that water is passed through the inlet port of the inlet/outlet ports 807 of the lid assembly 806 and via the water hose 818 (coupled to the lid assembly 806) to the water inlet coupler 817 of the UVC sterilization module 820. Water is then sterilized by the UVC light emitter unit 805 as the water passes through the UVC sterilization module 820 and enters the water outlet 812 to the lid assembly 806 before exiting the disinfection apparatus 800 (via the outlet port of the inlet/outlet ports 807) as sterilized water. As discussed herein, a water flow channel through the UVC sterilization module 820 includes a flow meter 814 (which can also be considered a flow switch) for detecting and/or measuring the flow of water through the UVC sterilization module 820 (see FIG. 9).

FIG. 9 is a schematic diagram of the interior components of the UVC sterilization module 820 of the disinfection apparatus 800. FIG. 9 is not drawn to scale and the exemplary components are not drawn to illustrate a particular physical arrangement. The exemplary components in FIG. 9 are drawn to illustrate interconnections and relationships between the components of the disinfection apparatus 800. A housing 816 of the UVC sterilization module 820 receives the inlet coupler 817 and passes water into an internal chamber of the UVC sterilization module 820 which is exposed to ultraviolet light from a UVC light emitter unit 805 for disinfection or sterilization of the water passing through the UVC sterilization module 820 (i.e., by ultraviolet light disinfection). A control module 802 is communicatively coupled to the UVC light emitter unit 805 to control the UVC light emitter unit 805. The control module 802 may be considered a controller circuit board (“controller”). In one embodiment the control module 802 and the UVC light emitter unit 805 are coupled together via control lines. In one embodiment the UVC light emitter unit 805 includes light emitting diodes (LEDs) that emit ultraviolet light. As discussed herein, the UVC light emitter unit 805 and the control module 802 are powered by low voltage DC, e.g., 12 V DC. This is the same voltage level as supplied to optional water pumps.

FIG. 9 also illustrates an exemplary flow meter 814 (also considered a “flow switch”) positioned in the stream of water passing through the UVC sterilization module 820. In one embodiment, when the flow meter 814 detects the flow of water through the UVC sterilization module 820, the control module 802 will activate the UVC light emitter unit 805. Similar to the operation of the UVC sterilization module(s) 420 discussed herein, the UVC sterilization module 820 and the control module 802 are energized (i.e., supplied with voltage, such as a low DC voltage) in response to the flow meter 814 sensing a flow of water through the flow meter 814. The flow meter 814 is coupled in-line with the inlet coupler 817, and before the water outlet 812, such that the flow meter 814 senses the flow of water passing through the UVC sterilization module 820 for sterilization by the UVC light emitter unit 805.

FIGS. 10A-10E illustrate an exemplary water treatment system 1000 configured with an exemplary disinfection apparatus 800. In one embodiment, the water treatment system 1000 includes at least one disinfection apparatus 800 and one or more filter devices (e.g., coarse filters 102 and/or fine filters 106). The water treatment system 1000 could also optionally include a water pump 104 (e.g., the water treatment system 150 of FIG. 1B). Alternatively, the water treatment system 1000 could be configured to passively receive and process water delivered to the water treatment system 1000 (e.g., the water treatment systems 150 of FIG. 1C). FIGS. 10A and 10B illustrate the disinfection apparatus 800 fitted with an outer canister 801, while FIGS. 10C, 10D, and 10E illustrate the disinfection apparatus 800 without the outer canister 801, such that the internal components are visible (e.g., a bottom fixture plate 804, a UVC sterilization module 820, a water inlet coupler 817, and a water hose 818). As illustrated in FIGS. 10A and 10B, the water treatment system 1000 could be configured with three canisters (FIG. 10A) or alternatively with at least two canisters (FIG. 10B). Thus, as also illustrated in FIGS. 10C-10E and 11B-11E, the disinfection apparatus 800 of FIGS. 10 and 11 is arranged such that water is passed through the inlet port of the inlet/outlet ports 807 of the lid assembly 806, and channeled via the water hose 818 to the water inlet coupler 817 of the UVC sterilization module 820. Water is then sterilized by the UVC sterilization module's UVC light emitter unit 805 as the water passes through the UVC sterilization module 820 (via the flow meter 814) and enters the water outlet 812 to the lid assembly 806 before exiting the disinfection apparatus 800 (via the outlet port of the inlet/outlet port 807) as sterilized water.

FIGS. 11A-11E illustrate another exemplary water treatment system 1100 configured with an exemplary disinfection apparatus 800. In one embodiment, the water treatment system 1100 includes at least one disinfection apparatus 800 and one or more filter devices (e.g., coarse filters 102 and/or fine filters 106). The water treatment system 1100 could also optionally include a water pump 104 (e.g., the water treatment system 150 of FIG. 1C). Alternatively, the water treatment system 1100 could be configured to passively receive and process water delivered to the water treatment system 1100 (e.g., the water treatment systems 150 of FIG. 1B). FIG. 11A illustrates the disinfection apparatus 800 fitted with an outer canister 801, while FIGS. 11B, 11C, 11D, and 11E illustrate the disinfection apparatus 800 without the outer canister 801, such that the internal components are visible (e.g., a bottom fixture plate 804, a UVC sterilization module 820, a water inlet coupler 817, and a water hose 818). As illustrated in FIGS. 11A and 11B, the water treatment system 1000 could be configured with three canisters (FIG. 11A) or alternatively with at least two canisters (FIG. 11B).

As illustrated in FIGS. 10A and 11B, the water treatment systems 1000, 1100 can optionally include a controller 110, a power button 130, and an indicator light 250. While FIG. 11A illustrates the controller 110, power button 130, and indicator light 250 associated with the water treatment system 1100, FIG. 10A illustrates the controller 110, power button 130, and indicator light 250 arranged on a housing of the water treatment system 1000. As discussed herein, the controller 110 is configured to control the operation of the water treatment system 1000, 1100, such as any equipped water pump 104 and/or disinfection apparatus (e.g., the disinfection apparatus 400, 800). Optionally, the controller 110 (and/or the control module 802) can control the pumping rate of the water pump 104 via a throttle functionality. The controller 110 (and/or the control module 802) can also control the amount of ultraviolet light released by the UVC light emitter unit 805. In one embodiment, the water treatment system 1000, 1100 includes a power button 130 for manually powering on the water treatment system 1000, 1100. Thus, a user is able (via the power button 130) to turn the fluid pump 104 and the disinfection apparatus 400, 800 ON and OFF as desired. The water treatment system 1000, 1100 can also include an indicator light 250 for indicating when the water pump 104 is operating and/or that the disinfection apparatus 400, 800 is functioning, that is, sterilizing the water flowing through the water treatment system 1000, 1100. The indicator light 250 can include red and green LEDs, such that the indicator light 250 illuminates a green indication light when water is flowing through the water treatment system 1000, 1100 and a red indication light when water is not flowing through the water treatment system 1000, 1100. Alternatively, the indicator light 250 can be used to provide a status of the water pump 104 and/or the disinfection apparatus 400, 800. In one embodiment, the indicator light 250 can be used to provide separate indications of the operation of the water pump 105 and of the disinfection apparatus 400, 800.

The disinfection system 100, 150, 1000, 1100 discussed herein may be used in a variety of ways. For example, the disinfection system 100, 150, 1000, 1100 may be used to supply filtered and/or disinfected water to a recreational vehicle. Such use may also allow for the disinfection system 100, 150, 1000, 1100 to be removeable and used in a portable fashion (in combination with a power source 210 and/or solar panel 220). In other words, the disinfection systems 100, 150, 1000, 1100 may be used in off-grid water disinfection situations (with the fluid pump 104 supplying 2-3 gallons of disinfected water a minute). When installed in a vehicle or in a portable configuration, the disinfection systems 100, 150, 1000, 1100 may be delivered to a location in need of disinfected water (such as after a natural disaster or other similar occurrence that has disrupted the supply of sanitary water). An advantage of the disinfection system 100, 150, 1000, 1100 described herein is its high-water flow rate of disinfected or sterilized water. That is, exemplary embodiments of the disinfection apparatus described herein may be implemented in a smaller canister size (e.g., a 5-inch canister) and with a higher water flow rate, than conventional water disinfection systems even with larger canister sizes (e.g., 10-inch canisters). A further advantage of the disinfection system 100, 150, 1000, 1100 over other water disinfectors is that the embodiments described herein are powered by low voltage DC and may be powered via batteries or suitable solar panels. Thus, the portable disinfection system 100, 150, 1000, 1100 may be used in locales (in need of clean water) with a shortage of reliable power.

Thus, a mobile disinfection system that optionally provides water filtering provides mobile water disinfection. The mobile disinfection system is powered via a low-voltage DC power source. The disinfection system may also include a pump (arranged within a pump canister) for drawing water through the system. The disinfection system includes a disinfection apparatus arranged within a canister that includes a UV light fixture for disinfecting water as the water passes through the disinfection apparatus. In one embodiment, the UV light fixture includes a trio of UV fixtures arranged in parallel within the canister for water disinfection. In another embodiment, the UV light fixture includes a single UV fixture (also arranged within the canister). The disinfection system includes a flow switch for controlling the operation of the UV light fixture by applying DC voltage to the UV light fixture when a flow of water is sensed by the flow switch. The disinfection system may also include a controller for controlling the operation of the optional water pump. The controller may also be used for controlling the operation of the UV light fixture. Thus, the controller may be used to control the selective delivery of a DC voltage to the optional pump and the UV light fixture. The pump and UV light fixture may utilize the same voltage level, e.g., 12 VDC. The DC voltage is drawn from a power source that is plugged into the disinfection system. Optionally, the power source is a battery (either internal or external). The power source may also include an AC-to-DC converter that outputs a DC voltage. The power source outputs a current sufficient to power both the pump and the UV light fixture. The controller may turn ON the pump while leaving the UV light fixture OFF. Alternatively, the controller may turn ON the UV light fixture while leaving the pump OFF (e.g., when an alternative means for drawing water is used). The power source is also configured to couple to a solar panel for charging. The use of a solar panel and battery allows for the portable use of the disinfection system away from conventional power sources. The components of the mobile disinfection system may include any combination of components as well as including or omitting any components. The components of the mobile disinfection system may be arranged in any desired configuration (with the pump and disinfection apparatus arranged within their respective canisters). The corresponding canisters of the disinfection system may also be arranged in a permanent or semi-permanent housing for incorporation into a water and wastewater system for a vehicle, structure, or other use that necessitates at least a semi-permanent water and wastewater handling system. The disinfection system thus provides disinfected water for use in potable water sources, such as faucets and drinking fountains.

Changes and modifications in the specifically described embodiments can be carried out without departing from the principles of the present invention which is intended to be limited only by the scope of the appended claims, as interpreted according to the principles of patent law including the doctrine of equivalents.

1. A water treatment system comprising:
a disinfection apparatus arranged within a disinfection canister and comprising an ultraviolet light fixture configured to disinfect water entering the disinfection apparatus and passing through the ultraviolet light fixture;
an inlet connector of the disinfection canister directly coupled to the disinfection apparatus and configured to allow water to enter the disinfection apparatus;
an outlet connector of the disinfection canister configured to output disinfected water received from the disinfection apparatus; and
a power source communicatively coupled to the disinfection apparatus and configured to output a DC voltage to the disinfection apparatus.

2. The water treatment system of claim 1, wherein the disinfection apparatus comprises a flow switch configured to apply the DC voltage to the ultraviolet light fixture when water flows through the flow switch.

3. The water treatment system of claim 2, wherein the disinfection apparatus comprises a controller configured to control the ultraviolet light fixture when the flow switch detects the flow of water through the flow switch.

4. The water treatment system of claim 1, wherein the ultraviolet light fixture comprises a plurality of ultraviolet light sub-fixtures arranged in parallel in the disinfection canister and configured to receive water from the inlet connector of the disinfection canister and output disinfected water to the outlet connector of the disinfection canister.

5. The water treatment system of claim 4, wherein the ultraviolet light fixture comprises at least one ultraviolet light emitter, and wherein each ultraviolet light sub-fixture of the plurality of ultraviolet light sub-fixtures comprises at least one ultraviolet light emitter.

6. The water treatment system of claim 5, wherein each ultraviolet light emitter is a light emitting diode (“LED”) ultraviolet source configured to emit ultraviolet light.

7. The water treatment system of claim 6, wherein the LED ultraviolet source is configured to emit UVC light.

8. The water treatment system of claim 1 further comprising a fluid pump configured to pump water when the DC voltage is selectively applied to the fluid pump, wherein the fluid pump is arranged within a pump canister and positioned in-line with respect to the disinfection apparatus such that the fluid pump either draws or pushes water into the disinfection apparatus via the outlet connector or the inlet connector of the disinfection canister, respectively.

9. The water treatment system of claim 1 further comprising a filter apparatus configured to filter the water before the water enters the disinfection apparatus, wherein the filter apparatus comprises at least one of a course filter arranged in a first filter canister and configured to filter sand/sediment from water passing through the course filter and a fine filter arranged in a second filter canister and configured to filter water passing through the fine filter, and wherein the fine filter is configured to filter out foreign material larger than a selected filter pore size.

10. The water treatment system of claim 9, wherein the selected filter pore size is smaller than 0.2 microns in diameter.

11. The water treatment system of claim 1, wherein the power source is a battery configured to output a DC voltage.

12. The water treatment system of claim 1, wherein the power source is an AC-to-DC converter.

13. The water treatment system of claim 1, 8, or 9 further comprising a frame or housing unit configured to retain and support any of the disinfection apparatus, the fluid pump, and the filter apparatus, each arranged in respective canisters.

14. A water treatment system comprising:
a disinfection apparatus arranged in a disinfection canister and comprising a plurality of ultraviolet light fixtures configured to disinfect water entering the disinfection apparatus and passing through each ultraviolet light fixture of the plurality of ultraviolet light fixtures;
an inlet connector of the disinfection canister directly coupled to the disinfection apparatus and configured to allow water entering the inlet connector of the disinfection canister to enter the disinfection apparatus;
an outlet connector of the disinfection canister configured to output disinfected water received from the disinfection apparatus;
a power source communicatively coupled to the disinfection apparatus and configured to selectively output a DC voltage to the disinfection apparatus.

15. The water treatment system of claim 14 further comprising a flow switch configured to control the application of the DC voltage to the plurality of ultraviolet light fixtures when water flows through the flow switch.

16. The water treatment system of claim 15, wherein the disinfection apparatus comprises a controller configured to control the plurality of ultraviolet light fixtures when the flow switch detects the flow of water through the flow switch.

17. The water treatment system of claim 14 further comprising a filter apparatus configured to filter the water before the water enters the disinfection apparatus, wherein the filter apparatus comprises a course filter arranged in a first filter canister and configured to filter sand/sediment from water passing through the course filter and a fine filter arranged in a second filter canister and configured to filter water passing through the fine filter, wherein the fine filter is configured to filter out foreign material larger than a selected filter pore size.

18. The water treatment system of claim 17 further comprising a fluid pump arranged in a pump canister and configured to pump water when the DC voltage is selectively applied to the fluid pump, wherein the fluid pump is positioned in-line with respect to the disinfection apparatus and the filter apparatus such that the fluid pump either draws or pushes water into the disinfection apparatus via the outlet connector or the inlet connector of the disinfection canister, respectively.

19. The water treatment system of claim 18 further comprising a frame or housing unit configured to retain and support the disinfection apparatus, the fluid pump, and the filter apparatus, each arranged within a respective canister.

20. The water treatment system of claim 14, wherein the power source is a battery configured to output a DC voltage or an AC-to-DC converter.
